(19) United States
(12) Patent Application Publication
(10) Pub. No.: US 2026/0248315 A1
(43) Pub. Date: Aug. 27, 2026

(54) Coffee Brewing Device

(71) Applicant: Parker Roth, Naples, FL (US)

(72) Inventor: Parker Roth, Naples, FL (US)

(21) Appl. No.: 19/061,211

(22) Filed: Feb. 24, 2025

(51) Int. Cl. A47J 31/02; A47J 31/06; A47J 31/08

(52) U.S. Cl. CPC A47J 31/02; A47J 31/0626; A47J 31/08

(57) ABSTRACT

A coffee brewing device includes a carafe with upper and lower portions and a pouring outlet, the lower portion holding brewed beverage, and a dripper coupled to the upper portion during brewing. A diffuser coupled to the dripper. The dripper remains stable when tilted to pour, allowing coffee dispensing without removal of the dripper.

### BACKGROUND

Traditional coffee brewing systems, such as pour-over coffee makers, pose multiple challenges that hinder user convenience and brewing quality. Typically, a dripper rests atop a carafe during brewing and must be removed before pouring, requiring users to handle a wet, grounds-filled component immediately, often causing spills or delays. Tilting the carafe, while the dripper is on top, can dislodge the dripper, spilling coffee grounds into the beverage or onto the serving area, affecting cleanliness and enjoyment. Uneven water distribution over the grounds leads to inconsistent extraction, and loose grinds escaping during pouring further diminish quality. While some companies have introduced separate cups to place wet drippers after brewing, this approach adds clutter, requires additional cleaning, and fails to address the underlying instability and brew inconsistencies, underscoring the need for a more effective solution.

### SUMMARY OF THE INVENTION

The Coffee Brewing Device is a pour-over coffee system that allows users to pour brewed coffee directly from a carafe without removing or handling a wet coffee dripper immediately after brewing. The carafe features an upper portion where the dripper remains securely positioned and a lower portion that holds the brewed coffee, with a pouring outlet for mess-free dispensing. Unlike traditional systems where tilting the carafe can dislodge the dripper, this device ensures stability during pouring, utilizing coupling to prevent spills and disruptions. The dripper is designed to receive coffee grounds and hot water and may serve as a built-in filter made of metal or other materials or be configured to hold a removable paper or fiber filter. The device can be paired with a hot water dispenser to automate the water-pouring process, reducing user effort and ensuring consistent brewing. Additionally, a diffuser can couple to the dripper and carafe to provide even water distribution over coffee grounds and help keep grounds from spilling out of the top of the dripper during pouring. The dripper, or both the dripper and diffuser, may be nested into the carafe as a means to retain heat and liquids, creating a more efficient and cleaner coffee experience. Designed for easy cleaning and compact storage, this system enhances convenience, minimizes mess, and streamlines the coffee brewing experience.

### DESCRIPTION OF THE DRAWINGS

FIG. 1 is a perspective view of an embodiment of a coffee brewing device.

FIG. 2 is an exploded perspective view of an embodiment of a coffee brewing device.

FIG. 3 is a cross-sectional view of an embodiment of a coffee brewing device.

FIG. 4 is a cross-sectional view of a coffee brewing device in the pouring position.

### DETAILED DESCRIPTION

A few of the preferred embodiments have been illustrated and described in detail. It is understood, however, that numerous modifications can be made without departing from the invention's scope as claimed. Although these embodiments specifically discuss coffee, the invention is applicable to any infusible substance with at least one infusible liquid. Those skilled in the art will recognize that many variations and substitutions may be made, qualifying as equivalents under the patent claims. The specific embodiments described herein are intended only to exemplify the invention and should not be seen as limiting its spirit or scope.

In the figures, not every element is assigned a reference number. Directional terms such as “front,” “rear,” “upper,” “lower,” “bottom,” “top,” and “side” are used to describe the orientation of the components as depicted in the drawings. Those skilled in the art will understand that these orientations may vary during actual use of the invention and are not intended to be limiting.

In the embodiment shown in the drawings, the coffee dripper device is transparent, allowing for visibility of the brewing process and fluid levels. The drawings utilize shading to illustrate depth and distinguish between different components.

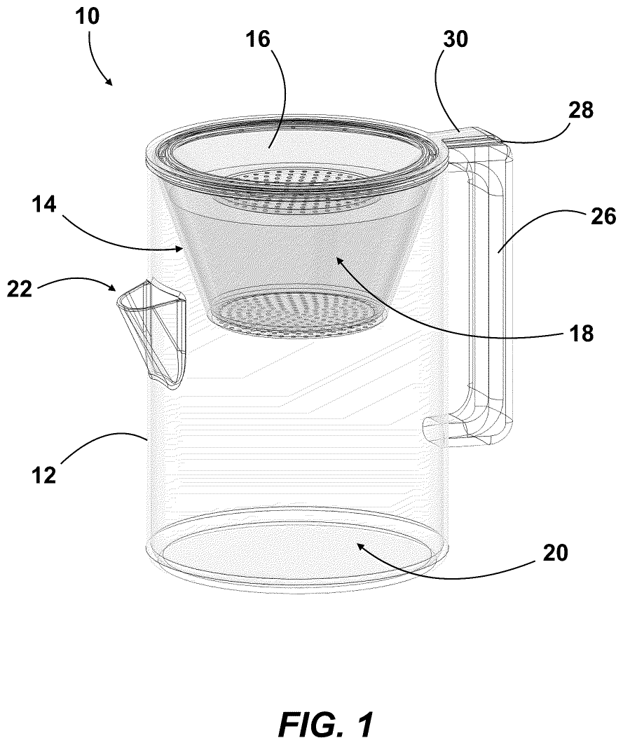

FIG. 1 is a perspective view of an embodiment of a coffee brewing device 10. The coffee brewing device 10 comprises a carafe body 12, which is sufficiently coupled to a dripper body 14, and the dripper body 14, in turn, is sufficiently coupled to a diffuser body 16. The carafe body 12 having a handle 26, designed for the user to pour the brewed beverage or move the coffee brewing device 10, and a beverage storage 20, designed to store the brewed liquid until the user pours it out through the outlet 22.

The coffee brewing device 10 features a fluid pathway 36, which directs the flow of liquid from either the diffuser fluid entrance 38 or the dripper fluid entrance 42 to the dripper fluid exit 44. The dripper fluid entrance 42, located at the top of the dripper body 14 and filter 18, receives hot water poured over a coffee bed within the filter 18. The user may pour hot water directly into the dripper fluid entrance 42, or, if a diffuser body 16 is present above the dripper body 14, the user may pour water into the diffuser fluid entrance 38. The diffuser body 16 is designed to regulate the volume and speed of water flow, converting an uncontrolled pour into a controlled, consistent distribution of water from the diffuser fluid exit 40 into the dripper fluid entrance 42. This manages the flow rate, improves water dispersion over the coffee bed, and helps retain heat throughout the brewing process. The diffuser has vent holes 46 to allow air to escape out of the dripper and diffuser so a vacuum does not form and stall the brew process.

The filter 18 serves as an infusion chamber, holding the coffee grounds while allowing water to pass through, extracting flavors and aromas. The brewed beverage then exits through the dripper fluid exit 44, located at the bottom of the filter 18 and dripper body 14, and flows into the carafe's beverage storage 20. The entire route from the diffuser fluid entrance 38, the top of the coffee brewing device 10, to the dripper fluid exit 44 constitutes the fluid pathway 36. Once collected in the beverage storage 20, the brewed coffee can be poured through the outlet 22 into a serving container.

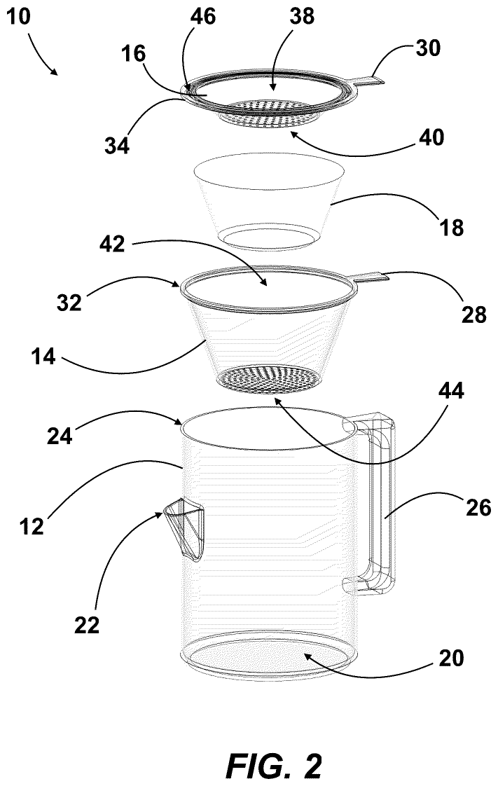

FIG. 2 is an exploded perspective view of the embodiment shown in FIG. 1, illustrating the components of the coffee brewing device 10, including the filter 18, dripper body 14, carafe body 12, and diffuser body 16. This view delineates the spatial relationship and assembly sequence of these components. The filter 18 is seated within the dripper body 14, which is supported on and coupled to the carafe body 12. The diffuser body 16 is coupled to both the dripper body 14 and the carafe body 12, ensuring proper alignment and stability during use. This configuration allows for secure coupling, efficient brewing, and controlled pouring, preventing spills and maintaining a clean and stable workflow.

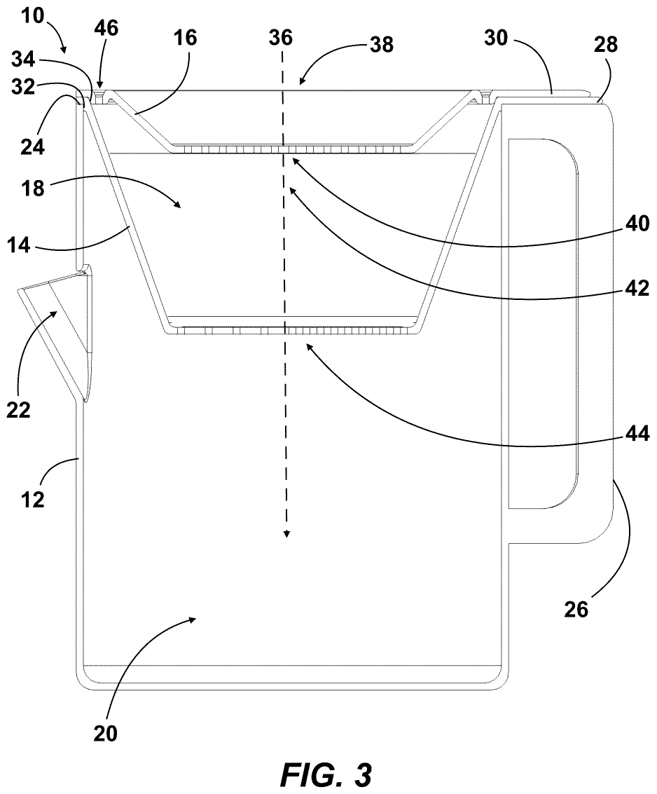

FIG. 3 is a cross-sectional view of an embodiment of the coffee brewing device, illustrating the coupling elements and their alignment. This view provides a clearer representation of how the dripper, diffuser, and carafe interact, ensuring stability and secure positioning during brewing and pouring. The coupling elements in this embodiment include a dripper tab 28, diffuser tab 30, dripper rim 32, and diffuser rim 34, all of which work to maintain alignment and coupling. The dripper rim 32 makes contact with the inner wall of the carafe body 12 and prevents shifting of the dripper within the carafe body 12. The diffuser rim 34 makes contact with the inner wall of the dripper body 14 to prevent shifting of the diffuser in the carafe body 12. The dripper tab 28 and diffuser tab 30 align on top of the handle 26 so the user may naturally us their thumb to press down on the tabs against the handle to further couple the components together for operation, while making it easy to disassemble for cleaning. While this figure represents one possible configuration, other embodiments may use different coupling methods or arrangements while still achieving sufficient stability and functionality within the scope of the invention.

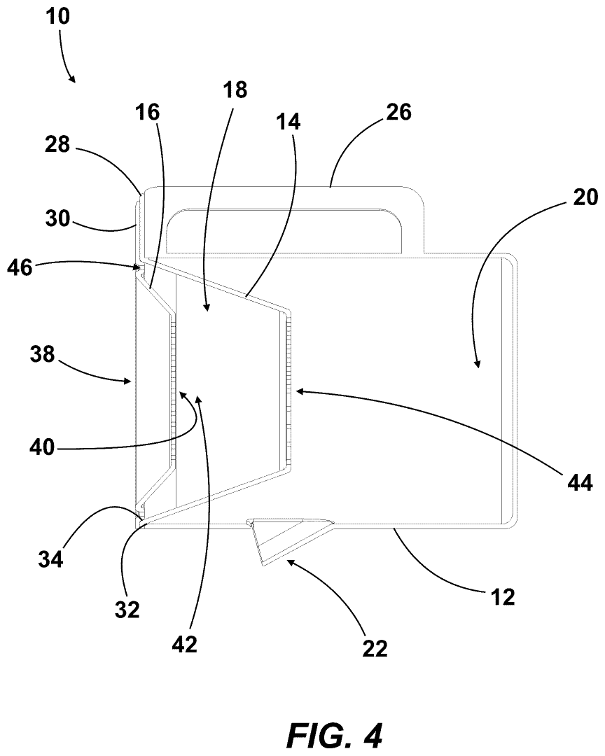

FIG. 4 is an illustration of the dripper in the pour position, demonstrating a key novel aspect of the invention. In existing designs, tilting the carafe for pouring, especial to completely empty the carafe, often results in spilled liquid, the dripper becoming dislodged, or coffee grounds spilling into the beverage, creating mess and inconvenience. Through the unique shape, structure, and function of the coffee brewing device, this invention ensures that the dripper remains securely coupled to the carafe even while in the pouring position. This allows the user to serve coffee immediately without having to stop and clean up first, maintaining a clean workflow and preserving heat for a better drinking experience. By preventing spills and keeping the brewing process efficient and mess-free, this system provides a superior alternative to conventional pour-over methods, while still allowing for easy disassembly and cleaning when desired.

In the embodiment shown in the drawings, the device includes both a dripper and a diffuser to enhance water distribution and brewing consistency. However, the novelty of the invention is not dependent on the presence of the diffuser, and the system remains functional and inventive without it. In alternative embodiments, the dripper alone may be used to achieve stable brewing and pouring, with or without additional flow regulation mechanisms. While the diffuser may provide benefits such as even water dispersion, preventing coffee grounds from escaping, and maintaining brew temperature, its absence does not alter the core inventive concept of a securely coupled brewing system that allows for stable pouring without requiring the removal of the dripper. Other variations may include integrated or external water distribution features, but all remain within the intended scope of the invention.

In the embodiment shown, the diffuser is shallow, designed to provide controlled water dispersion while maintaining a compact form. However, in other embodiments, the diffuser may be configured as a larger water reservoir or tank, allowing the user to pour a greater quantity of water at once and walk away while the water gradually dispenses over the coffee bed. This variation enables a more automated pour-over experience, reducing the need for continuous user attention while still ensuring even water distribution and optimal extraction.

The number of passages through which water diffuses in the diffuser does not impact the scope of the claims, as the invention is not limited to a specific number of openings. The only requirement is that the diffuser includes at least one passage to allow water to flow through and distribute over the coffee bed. In different embodiments, the size, shape, and quantity of passages may vary to optimize flow rate, water dispersion, and extraction efficiency, but these variations do not alter the core inventive concept. Whether the diffuser has a single opening or multiple passages, it remains within the scope of the invention, as long as it performs the function of regulating and directing water flow during brewing while maintaining sufficient coupling to the dripper and carafe.

In the embodiment shown in the drawings, a combination of different coupling elements prevents the dripper and diffuser from shifting or falling out of the carafe. This embodiment utilizes rim contact to maintain alignment and restrict lateral movement, while tabs positioned over the handle allow the user to impart downward force naturally when tilting the carafe into its pouring position. Together, these features create a system of both geometric and manual coupling, ensuring stability during use. However, other embodiments may exist without handles and instead utilize alternative coupling methods to achieve the same function. “Sufficient coupling” refers to any mechanism that allows the carafe to be tilted into a pouring position without the dripper or the dripper and diffuser becoming unstable, dislodged, or misaligned.

Other coupling methods include, but are not limited to, threads, friction fit, compression seals, locking tabs, detents, snap-fit connections, interference fits, and adhesive or semi-permanent bonding methods. Additionally, magnetic elements, suction forces, or vacuum seals may be used in alternative embodiments to provide secure and stable engagement between the dripper, diffuser, and carafe. The specific coupling method used may vary depending on material selection, user preferences, and manufacturing constraints, but all variations remain within the intended scope of the invention as long as they provide sufficient coupling to maintain stability during pouring.

Although the coupling may be strong enough to allow the device to be turned completely upside down without the components decoupling, the invention does not require such an extreme level of retention. The coupling only needs to be sufficient to keep the components secured during normal use, specifically allowing the carafe to be tilted to approximately 90 degrees or, depending on the design of the embodiment, more or less to fully empty the brewed beverage. Additionally, ease of decoupling is advantageous to the user for cleaning, disassembly, and reassembly purposes, allowing for a more efficient and user-friendly experience. Variations in coupling strength, method, or placement do not depart from the scope of the invention, as long as the system remains stable during the intended pouring motion while allowing for practical separation when needed.

In the embodiment shown in the drawings, the dripper includes its own coupling elements to secure it to the carafe. However, other embodiments may utilize the diffuser as the primary coupling component, where the diffuser couples to the carafe and, in doing so, also secures the dripper in place. This arrangement can achieve a net sufficient coupling, ensuring stability during brewing and pouring. By relying on the diffuser for coupling, the dripper itself can be constructed in a more economical way or made from different materials or shapes than would typically be required for direct coupling. This flexibility allows for variations in design, cost optimization, and material selection, while still maintaining the core function of stability and ease of use. Whether the dripper, the diffuser, or a combination of both provides the primary coupling does not escape the spirit of the invention, as the core concept remains a secure, stable brewing system that allows for controlled pouring without dislodging components. Different coupling configurations may be implemented based on design preferences, materials, or user needs, all while remaining within the intended scope of the invention.

In the embodiment shown in the drawings, the dripper and diffuser are mostly nested within the carafe, providing several advantages, including keeping the brewing area clean during the brew and serve process, enhancing stability by maintaining a low center of gravity relative to the carafe, and improving heat retention. However, the invention is not limited to a fully nested configuration, and other embodiments may feature the dripper and diffuser in a partially nested or entirely non-nested arrangement while still maintaining the core functionality of secure coupling and stable pouring. Variations in nesting depth may be influenced by design preferences, material selection, and user needs, but all remain within the spirit of the invention as long as they enable effective brewing, controlled pouring, and sufficient coupling for stability.

The bodies of the carafe, dripper, and diffuser are each constructed independently as either a unibody structure or as separate components that couple together during use. These components may be made from the same or different materials, including but not limited to metal, plastic, ceramic, and glass. However, merely dividing or combining these structures without altering their fundamental function does not depart from the invention's scope. Any attempt to reconfigure the structure while maintaining the same stability, fluid retention, and coupling remains covered by the claims, as the invention lies in its functional integration, whether as a single piece or multiple components.

In some embodiments, the dripper and the carafe may be integrated into a single, non-removable unit, eliminating the need for separate coupling components. While this configuration simplifies construction, it is less ideal for cleaning and maintenance, as users cannot easily disassemble the components for thorough washing. However, this variation remains within the spirit and scope of the claims, as the core inventive concept of stable brewing and pouring without removing the dripper is preserved. Alternative designs may incorporate built-in access points, wider openings, or self-cleaning features to mitigate cleaning challenges while maintaining the functionality of the brewing system.

The dripper and carafe in this embodiment are shown as being constructed from single-wall borosilicate glass. However, other embodiments may feature single or double-walled constructions to enhance heat retention, durability, or user safety. A double-walled dripper or carafe may provide better thermal insulation, keeping the brewing temperature stable for a longer duration, while a single-walled version may offer a more lightweight and cost-effective design. The choice of wall construction can vary based on material selection, manufacturing techniques, and user preferences, but all such variations remain within the scope of the invention, as long as the core functionality of stable coupling, controlled brewing, and efficient pouring is maintained.

The outlet is designed to effectively deliver the brewed beverage from the beverage storage area into the user's container of choice in a controlled manner. The spout is a simplified descriptor for an outlet for dispensing a brewed beverage. Spout is used in this embodiment, any outlet is to be protected in the claims. In this embodiment, the spout is open and positioned in the upper middle portion of the dripper, allowing for a smooth and directed pour. However, other embodiments may feature a spout that is partially or fully enclosed, repositioned higher or lower on the dripper or carafe, or modified in shape or size to optimize flow control, prevent drips, or accommodate different pouring techniques. These variations do not escape the scope of the invention, as the essential function of controlled beverage delivery remains unchanged, regardless of spout placement or configuration.

Although this embodiment features an open spout as the outlet, a spout door, flap, or other closure mechanism may be incorporated in other embodiments to help retain heat in the beverage and provide additional control over pouring. A spout closure may be manually operated, spring-loaded, or automatically opened during pouring, depending on the design. This modification does not alter the core functionality of the device, as the essential elements of controlled pouring, stability, and coupling remain unchanged. The inclusion of a spout door or similar feature serves to enhance thermal retention, reduce heat loss, and improve user experience, all while remaining within the intended scope of the invention.

In the embodiments described herein, the coffee dripper is shown using a flat-bottom paper filter without a wave structure; however, one skilled in the art will recognize that the scope of the invention is not limited to this specific filter type or shape. The dripper may accommodate various filter materials, including but not limited to paper, metal, cloth, fiber, or composite materials, and may be designed to hold filters of different geometries, such as cone-shaped, semi-cone, flat-bottom, hybrid flat-cone, or any other functional shape. The invention is also not restricted to any specific filter brand or standard and is fully compatible with commercially available filter designs, including but not limited to those from Melitta, Kalita, Hario, Cafec, and other manufacturers. Additionally, the dripper itself may incorporate small passages, perforations, or mesh structures that function as an integrated filter, allowing it to be used with or without a separate filter medium. These integrated filtering features may be designed to control flow rate, particle retention, and extraction consistency, further enhancing the flexibility and performance of the system. The system is designed to function with any filter type or built-in filtering mechanism, ensuring versatility and broad applicability within the field of coffee brewing.

This embodiment is shown as a standalone device, where the user manually pours hot water into the dripper. However, one skilled in the art will recognize that this system can be paired with an automatic hot water dispensing device to create a more automated brewing experience. In such an embodiment, a water delivery system could be integrated or externally positioned to dispense heated water directly into the top of the carafe, eliminating the need for the user to manually pour hot water. This could include gravity-fed reservoirs, electric pump systems, or pressurized water dispensers, all of which would still align with the core inventive concept of a stable, coupled brewing system. The automation of water delivery does not alter the novelty of the dripper and carafe coupling system, and such variations remain within the scope of the invention.

What is claimed is:

1. A coffee brewing device comprising:
a carafe including an upper portion, a lower portion configured to hold a brewed beverage, and a pouring outlet for dispensing a brewed beverage;
a dripper positioned within the upper portion of the carafe, the dripper configured to hold coffee grounds and including a fluid exit to allow brewed coffee to flow into the lower portion;
wherein the dripper is coupled to the carafe such that the dripper remains securely positioned relative to the carafe when the carafe is tilted to pour the brewed beverage through the pouring outlet.

2. A coffee brewing device comprising:
a carafe including an upper portion, a lower portion configured to hold a brewed beverage, and a pouring outlet for dispensing a brewed beverage;
a dripper positioned within the upper portion of the carafe, the dripper configured to hold coffee grounds and including a fluid exit to allow brewed coffee to flow into the lower portion;
a diffuser positioned above the dripper, the diffuser configured to receive hot water and distribute the hot water over the coffee grounds;
wherein the dripper and the diffuser are coupled to the carafe such that the dripper and the diffuser remain securely positioned relative to the carafe when the carafe is tilted to pour the brewed beverage through the pouring outlet.

3. A coffee brewing device comprising:
a carafe including an upper portion, a lower portion configured to hold a brewed beverage, and a pouring outlet for dispensing a brewed beverage;
a dripper positioned within the upper portion of the carafe, the dripper configured to hold coffee grounds and including a fluid exit to allow brewed coffee to flow into the lower portion;
a diffuser positioned above the dripper, the diffuser configured to receive hot water and distribute the hot water over the coffee grounds, wherein the diffuser is coupled to the carafe and secures the dripper in place;
wherein the dripper and the diffuser remain securely positioned relative to the carafe when the carafe is tilted to pour the brewed beverage through the pouring outlet.

4. The coffee brewing device of claim 1, wherein the dripper is removably coupled to the carafe via a friction fit.

5. The coffee brewing device of claim 1, wherein the dripper is removably coupled to the carafe and includes a rim that contacts an inner wall of the carafe to prevent lateral movement.

6. The coffee brewing device of claim 1, wherein the dripper is removably coupled to the carafe and includes a tab that aligns with a handle of the carafe, allowing a user to apply downward force to secure the dripper.

7. The coffee brewing device of claim 1, wherein the dripper is integrally formed with the carafe.

8. The coffee brewing device of claim 1, wherein the dripper includes a filter for holding the coffee grounds.

9. The coffee brewing device of claim 1, wherein the filter is a removable paper filter.

10. The coffee brewing device of claim 1, wherein the dripper includes a built-in metal filter.

11. The coffee brewing device of claim 1, wherein the carafe includes a handle for grasping and tilting the carafe.

12. The coffee brewing device of claim 1, wherein the carafe is made of glass.

13. The coffee brewing device of claim 1, wherein the carafe has a double-walled construction for heat retention.

14. The coffee brewing device of claim 2, wherein the diffuser includes vent holes to allow air to escape during brewing.

15. The coffee brewing device of claim 2, wherein the diffuser is removably coupled to the dripper.

16. The coffee brewing device of claim 2, wherein the diffuser includes a rim that contacts an inner wall of the dripper to prevent lateral movement.

17. The coffee brewing device of claim 2, wherein the diffuser is configured to prevent coffee grounds from spilling out of the dripper during pouring.

18. The coffee brewing device of claim 2, wherein the diffuser is coupled to the carafe via threads.

19. The coffee brewing device of claim 3, wherein the diffuser secures the dripper by pressing it against the carafe.

20. The coffee brewing device of claim 1, wherein the dripper is configured to retain the coffee grounds during pouring, allowing the brewed beverage to be dispensed without removing the coffee grounds.
